(19) United States
(12) Patent Application Publication
(10) Pub. No.: US 2009/0094140 A1
(43) Pub. Date: Apr. 9, 2009

(54) Methods and Apparatus for Inventory and Price Information Management

(75) Inventor: Sik Piu Kwan, Suwanee, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/866,642

(22) Filed: Oct. 3, 2007

(51) Int. Cl. G06Q 10/00; G06Q 90/00

(52) U.S. Cl. 705/28

(57) ABSTRACT

Systems and techniques for managing product inventory and pricing and product information. A moving camera platform is directed to desired locations in an environment to capture visual information relating to shelf labels affixed to shelves in the environment and visual information relating to products on the shelves. Image recognition is performed on the visual information to extract information on the shelf labels. The information from the shelf labels is compared against corresponding stored information, and mismatches between the shelf label information and the stored information are noted. Image recognition is also performed on the visual information to extract inventory information of the products. The inventory information is also compared against corresponding stored information, and mismatches between the inventory information and the stored information are also noted.

### FIELD OF THE INVENTION

The present invention relates generally to improvements to systems and methods for inventory and price checking for a retail establishment. More particularly, the invention relates to low cost automated systems for surveying retail inventory and price labeling.

### BACKGROUND OF THE INVENTION

Many retailers, particularly supermarkets, typically sell very large numbers of relatively low priced products. A typical supermarket may offer thousands of different products, having different price and inventory control information. Tens or hundreds of each one of the many products sold may be placed on the shelves. In order to comply with pricing regulations, and to insure continued customer satisfaction, price information presented to consumers, such as price labels placed on shelves near products must be kept current. In addition, to provide for sales opportunities and to insure customer satisfaction, inventory must be available on store shelves when customers wish to purchase it. Furthermore, information relating to the amount of inventory available provides insight into the rate of sales, and can also be employed to detect theft.

In order to maintain current pricing and to provide for inventory control, retailers frequently rely on manual price and inventory checking, in which designated employees conduct surveys of price information and examine inventory to make sure that sufficient inventory is present on shelves and available for shelving. Employees are also typically designated to track the rate of inventory depletion. The rate of inventory depletion may be examined to determine product sales rates and replacement product needs, and audits may be made so as to compare the amount of inventory actually in stock against sales and inventory records to detect theft.

### SUMMARY OF THE INVENTION

Among its several aspects, the invention recognizes that manual inventory and price label checking involve significant recurring labor costs. In addition, the invention recognizes that prior art alternatives to manual checking and updating frequently involve comprehensive substitution of paper labels with a system employing electronic labels that receive and display product information. Examples of systems using addressable labels are electronic shelf label systems and radio frequency identification (RFID) systems. Replacement of paper labels with either of these types of systems involves substantial costs for a significant amount of duplicate hardware. For example, an electronic shelf label system includes numerous electronic shelf labels, with each shelf label having significant cost, as well as centralized equipment to manage communication with the labels and distributed equipment to perform communication with labels. The distributed equipment is typically in the form of communication base stations, with each communication base station addressing a group of labels. An RFID system employs numerous RFID readers to read RFID tags on products and display product information, and involves expenditures for numerous readers, as well as the requirement that RFID tags be placed on products.

The present invention addresses such problems, as well as others, by allowing a retailer to continue to use inexpensive paper labels, while providing a mechanism that can be fully or partially automated and which performs a survey of the labels and inventory, typically by visual means. Such a system significantly reduces periodic costs as compared to manually updated paper labels, while allowing for a substantially reduced capital outlay as compared to electronic label systems such as electronic shelf labels and RFID systems.

One embodiment of the invention comprises an automated mobile platform, suitably carrying an imaging device, such as a digital camera capable of capturing video or still pictures, as desired. The camera transmits images to a computer, which uses image recognition techniques to read price information and otherwise interpret images received from the camera. Suitably, the platform and camera are disposed and oriented so as to capture images of shelf price information and other price information labels and signs, and to capture images of the products themselves. Using suitable image recognition and processing software, the computer is able to compare price displays against price information stored in a price database, to recognize if the products on a shelf are being depleted, and to recognize whether or not the products are organized properly for display. The computer is also able to use images of the surroundings of the camera platform to guide the platform, and to send control commands to the platform to guide it in appropriate directions.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a price checking and inventory control system according to an aspect of the present invention;

FIGS. 2 and 3 illustrate views of a mobile camera platform used in a price checking and inventory control system according to an aspect of the present invention;

FIG. 4 illustrates details of a computer used to process visual image data and transmit commands to a camera platform according to an aspect of the present invention; and

FIG. 5 illustrates a process of price checking and inventory control according to an aspect of the present invention.

### DETAILED DESCRIPTION

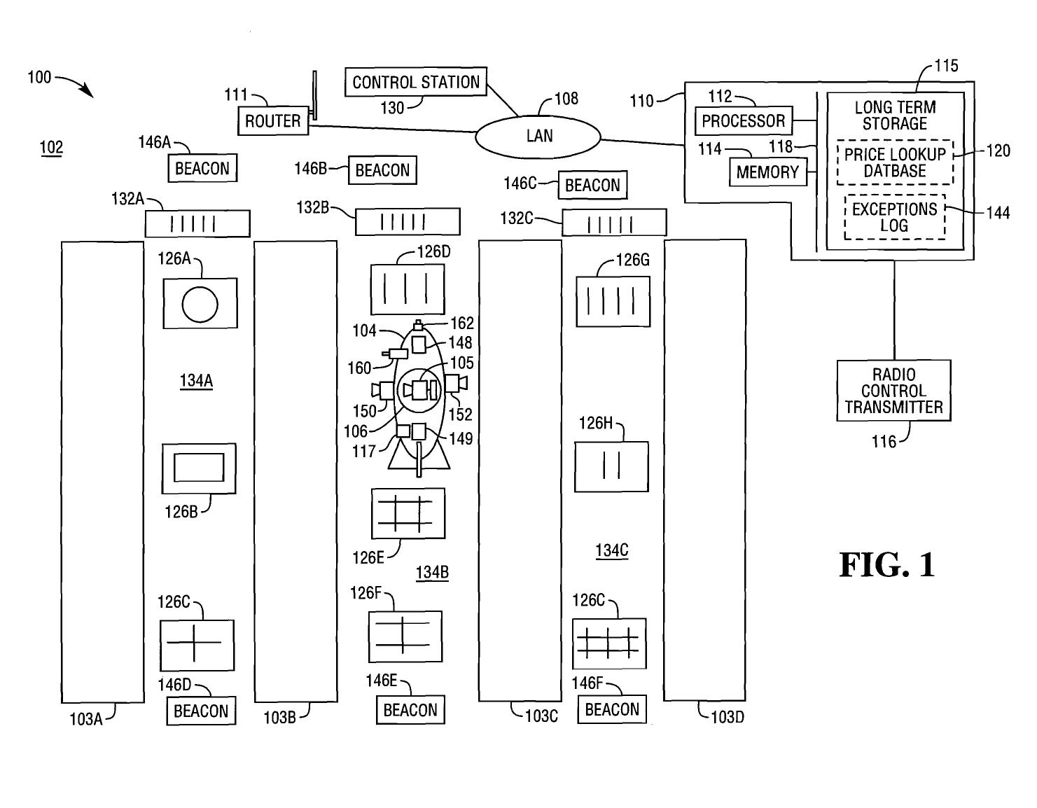

FIG. 1 illustrates a system 100 of price checking and inventory control according to an aspect of the present invention. The system 100 may suitably be deployed in a retail location 102, featuring a plurality of shelves such as the shelves 103A-103D. The shelves 103A-103D are used to present products sold for retail, and include shelf labels including product and pricing information.

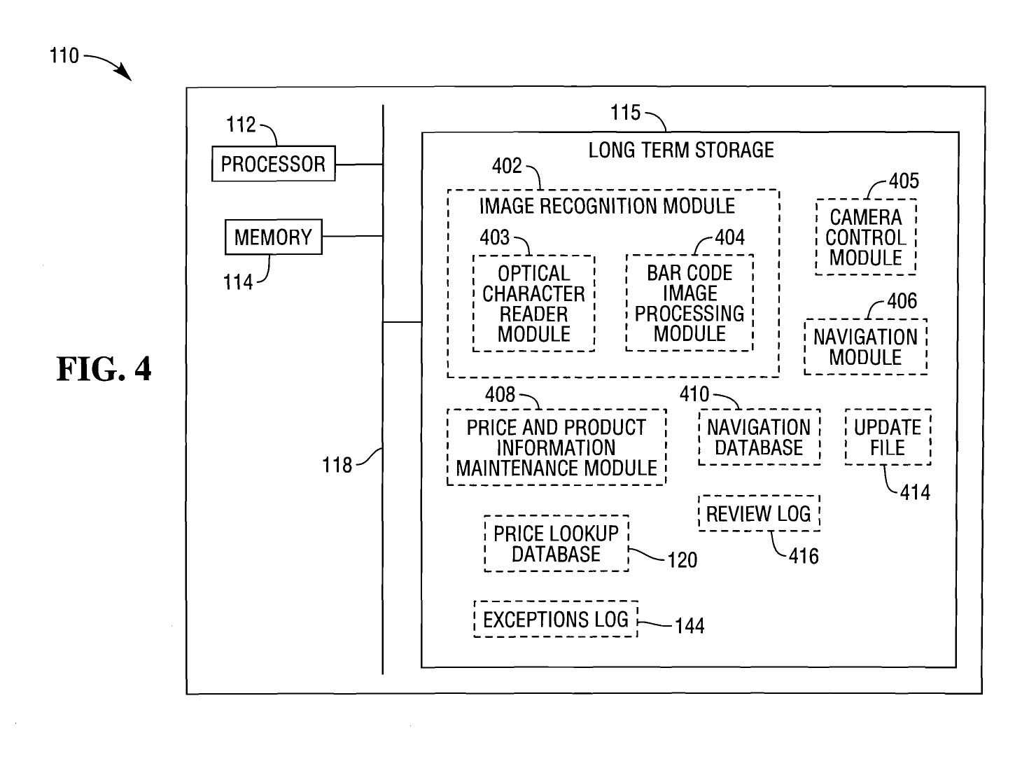

The system 100 suitably includes a freely moving camera platform, suitably in the form of a model airship 104, carrying a digital camera 105, suitably mounted on a platform 106 allowing swiveling and tilting of the camera 105, and communicating through a wireless communication system such as a wireless local area network 108 employing a price and inventory control computer 110 and a wireless router such as the router 111. The computer 110 includes a processor 112, memory 114, and long term storage 115, suitably communicating over a bus 118. The computer 110 includes a price lookup database 120, hosted on the long term storage 115. The computer 110 hosts additional data and software for controlling the airship 104 and collecting and updating price information. This additional data and software is described in greater detail below in connection with FIG. 4.

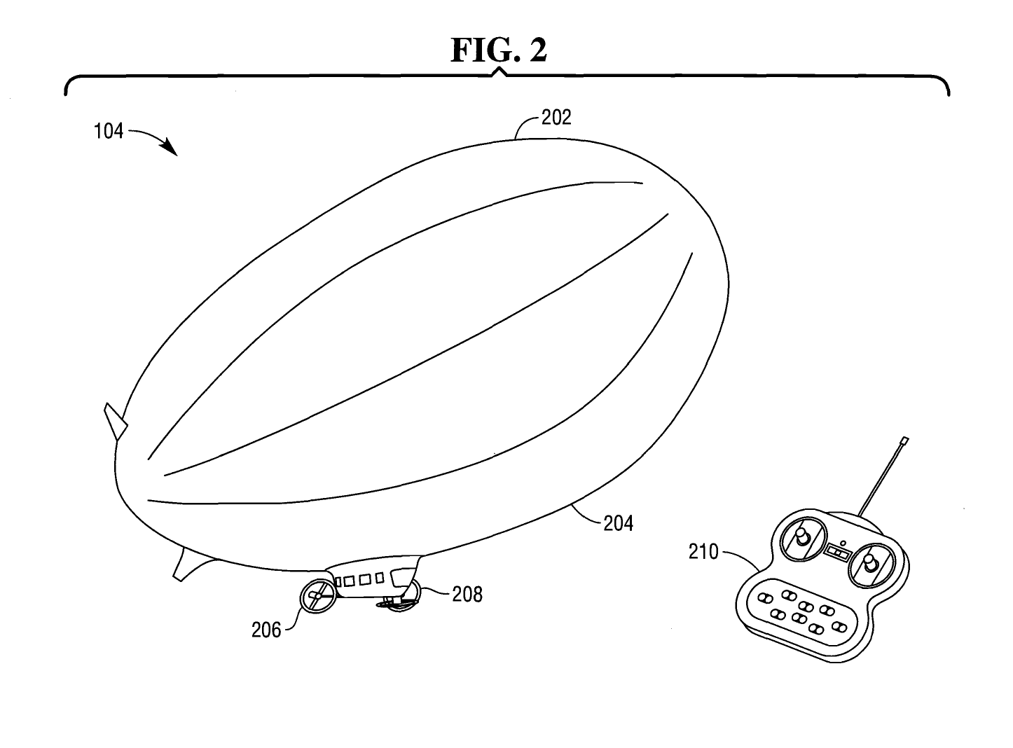

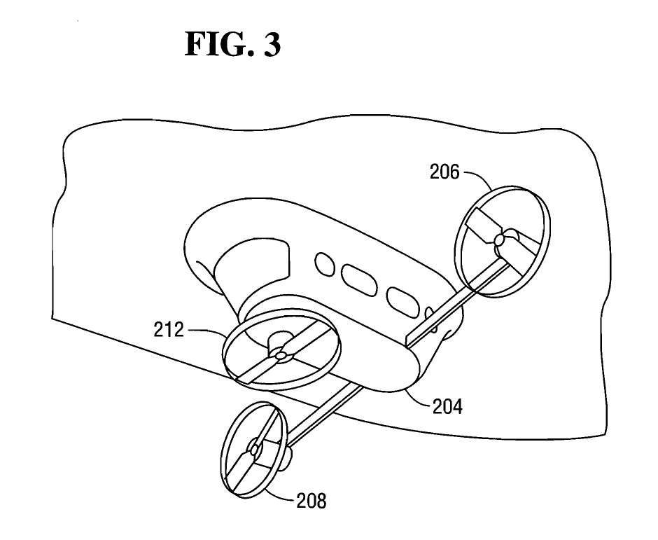

The airship 104 is preferably capable of being remotely controlled through radio signals, and the computer 110 suitably controls the travel of the airship, for example, using a radio control transmitter 116. Alternatively, the computer 110 may transmit directional commands to the airship 104 over the wireless network 108, with these commands being received and implemented by an appropriate device, such as an onboard computer 117. Airships such as the airship 104 are available from a number of vendors with included radio control transmitters included that are suitably for manual control. The radio control transmitter 116 suitably emulates such included radio control transmitters, but is adapted for automated computer control. The airship 104 is illustrated here as carrying the camera 105 on its top, but it will be recognized that the camera 105 may be located in any position allowing for efficient and controlled flight of the airship 104. For example, the airship 104 may suitably include a suspended gondola, not visible in FIG. 1, but visible in FIGS. 2 and 3. A camera such as the camera 105, or additional cameras, may suitably be carried on the suspended gondola, or the camera may be directly secured to a suitable structure built into the airship 104. The airship 104 moves according to commands issued by the computer 110 and delivered through the radio control transmitter 116, in order to bring objects into a field of view of the camera as desired. In addition, the camera 105 is suitably capable of panning and tilting, for example, by rotating and tilting the platform 106. The camera 105 is also suitably capable of zooming on command, and the elements used to adjust the field of view of the camera 105, such as the camera 105 itself and the platform 106, may include suitable controls actuated by radio signals, in order to give the camera 105 additional flexibility in capturing appropriate fields of view in addition to the capability provided by moving the airship 104.

The airship 104 preferably comprises a helium filled balloon, providing the airship with buoyancy and the ability to travel at as low a speed as desired, and to remain stationary, if desired, without an expenditure of energy. The slow speeds at which the airship is capable of traveling allow for relatively imprecise techniques for controlling the airship. It is not necessary for the airship to be precisely directed to desired destinations. Instead, the airship may be controlled so that it moves in what is known to be approximately the desired direction, and its position may be verified from time to time. For example, encoded position markers such as the markers 126A-126I may be deployed throughout the location 102, and the airship 104 may be directed to adjust its direction when recognition of a marker or succession of markers indicates that the airship 104 is traveling in the wrong direction. The computer 110 suitably transmits suitable radio signals compatible with a radio control receiver built into the airship 104. The radio control receiver is not visible here, but may suitably be of a known type used for control of radio controlled vehicles. In addition, the camera 105 may be a camera designed for wireless communication for control of the camera 105 and for transmission of images taken by the camera 105, suitably over a computer network such as the wireless local area network 108, and the computer 110 may wirelessly direct the operation of the camera 105 through communication over the wireless local area network 108.

The computer 110 is suitably programmed with appropriate control software compatible with the configuration of the preinstalled radio control receiver and controls of the airship 104, and directs the airship 104 along paths calculated to provide desired visual information. This visual information suitably includes images of shelf price labels and other price labels visible to customers. Price labels typically identify the products with which they are associated, so that once a price label has been recognized and interpreted by the computer 110, the price and product information reflected on the label can be compared against stored price and product information for the product. Visual information that may be obtained also suitably includes images of the products themselves, in order to provide an indication of the amount of inventory of each product. If the image information can be sufficiently finely resolved, a count of the number of units of a product that are present can be made. The image information may also be able to be interpreted to determine whether the products are in an orderly arrangement on the shelves. Alternatively, or in addition, the image information may be monitored by an attendant, for example, at a control station 130. The control station 130 may also include facilities allowing an attendant to control the airship 104, rather than having the airship 104 be automatically controlled by the computer 110. As a further alternative, image information itself may be recorded, for example, as a moving video clip or as a collection of still frames of objects of interest.

The airship 104 is directed along paths that will provide the needed visual information with reasonable efficiency. A particular path of travel may be preprogrammed or alternatively the computer 110 may calculate a desirable path based on the price information that needs to be reviewed. Preferably, every accessible price label is surveyed over some period, but all labels do not necessarily need to be surveyed at once. The location 102 may be divided into sections, with a travel plan computed for each section. Numerous alternative choices of travel paths may be made. For example, the airship 104 may be directed to travel continuously, except for recharging periods, with the route of travel being adapted so as to survey labels that have not been recently surveyed, with attention being given to avoid backtracking so as to avoid unnecessary travel and a consequent need for recharging. As another alternative, one possible routing is a routing directed to survey labels that have been missed during a previous comprehensive survey.

The airship 104 is suitably controllable to move forward, to turn 360 degrees to the left or right, and to rise and sink as a result of the action of motorized propellers controlled under the command of the computer 110. As a lighter than air craft, the airship 104 can also hover in place with minimal expenditure of energy. The approximate position of the airship 104 may be determined based on the image or sequence of images received. Location information for objects such as price labels, signs, markers such as the markers 126A-126I, and other objects and references that can be used to indicate the position of the airship 104 is stored in a navigation database, which may be stored in the long term storage 115 or otherwise accessible to the computer 110. The navigation database, and additional software and data elements, are not shown in FIG. 1, but are illustrated in FIG. 4 and discussed below.

The images or sequences of images that come into the view of the camera 105 are matched against object information stored in the database, and location information associated with those objects is used to determine the location and direction of the airship 104. Suitably, location information is determined using objects that are easily processed and interpreted, such as printed text, large, easily visible objects having distinctive colors, designs, or both, or similarly distinctive objects.

The computer 110 suitably directs the operation of the camera 105, panning and tilting the camera 105 with respect to the airship 104 as needed, and zooming the camera in and out as needed to widen the visual field in order to search for objects of interest or narrow the visual field to concentrate on an object of interest and to process an image.

To conduct a price survey in the location 102, the airship 104 may be launched without any immediate need to be oriented as to position at the time of launching. The computer 110 operates the camera 105 under a suitable searching routine, calculated to find and recognize a shelf label, position indicator, or other visual reference that can be used to determine the position of the airship 104. Once an indicator has been located, the computer 110 suitably directs the airship to a position relatively close to the indicator, while searching for additional indicators, in order to obtain a relatively close approximation of the position and orientation of the airship 104. If the position can be determined, the computer 110 directs the airship 104 along a suitable survey course, for example along the aisles of the location 102, making appropriate turns upon encountering aisle termination markers such as the marker 132A at the end of the aisle 134A between shelves 103A and 103B. A similar marker 132B appears at the end of the aisle 134B between shelves 103B and 103C, and a similar marker 132C appears at the end of the aisle 134C between shelves 103C and 103D. As the airship 104 travels along each of the aisles, the camera 105 is directed to examine the shelves along its route of travel. The airship 104 may be directed along any appropriate course along the aisle 134A, for example, first to one side, and then to another. As the computer 110 receives label information, the direction of travel of the airship 104 becomes better known, and this information can be used to direct the airship 104 more precisely.

If the camera 105 does not immediately encounter an indicator the airship 104 may be directed along an appropriate search path, such as in an unobstructed direction, in order to find an appropriate indicator and determine the location and direction of the airship 104.

As an alternative, the airship 104 may be launched from a known location, suitably with the camera 105 directed toward a suitable indicator, and then directed along an appropriate path by the computer 100.

The computer 110 suitably controls the travel of the airship using navigational software hosted on the long term storage 115. The navigational software computes the approximate position of the airship 104 using the navigation database, which may include information identifying and giving positions of various markers and visual references. The navigation database may also include label position information, allowing the travel of the airship 104 to be controlled by reference to shelf labels. The airship may suitably be directed not by reference to geographical directions, but by reference to the markers or labels that come into the view of the camera 105, using information relating to the relative position of markers to indicate whether it needs to make a left or right turn, to rise or ascend, or to continue or reverse its direction of travel. As the airship 104 travels, the camera 105 is directed at objects of interest, such as shelf labels or shelf contents. The computer 110 receives and processes the information, using image processing to interpret label information. When a label is processed and interpreted, the label information is compared against the price and inventory database 120. When a label does not match the price lookup database 120, an exceptions log 144 may suitably be updated. The exceptions log 144 may be reviewed periodically and may be used to correct and update label information, or in any other desired fashion.

In addition or as an alternative to navigating through visual recognition, the airship may be navigated through any number of other means. For example, beacons 146A-146F-may be deployed throughout the location, with the emissions of the beacons 146A-146F being detectable by one or more sensors such as the sensor 148 mounted on the airship 104. The airship 104 may suitably be equipped with an autopilot system 149, which may receive navigation directions from the computer 110. The navigation directions may suitably be based on the beacon signals, and may direct the airship 104 toward or away from one or another of the beacons 146A-146F, or may direct the airship 104 to travel along a particular beacon signal toward an intersection of two beacon signals, or to travel with respect to the beacon signals in any manner desired. The beacons 146A-146F may suitably be directional or omnidirectional radio frequency beacons, infrared or visible light beacons, or any other type of beacon meeting the needs of the system 100 and the environment in which it is deployed.

Numerous enhancements and modifications may be made to a system such as the system 100. Numerous alternative digital cameras such as the camera 105 may be used. One particularly advantageous feature that may be used in a camera such as the camera 105 is image stabilization. Image stabilization compensates for movement of a camera, leading to a higher image quality and faster image recognition. Such stabilization may also compensate for low speed motion, allowing for image capture and image recognition without stopping the airship 104.

The airship 104 may carry numerous additional cameras, such as the cameras 150 and 152, allowing image capture from multiple directions simultaneously, increasing the efficiency of image recognition and image capture. In addition, image recognition may be performed on board if a suitable computer is mounted on the airship 104. In such a case, the image recognition and navigation functions performed by the computer 110 can be performed on board the airship 104 instead, with navigation of the airship 104 being controlled through direct connection with airship controls rather than depending on radio control by a remote computer. Such a technique reduces traffic on the network 108, because only the completed image recognition results, rather than the images to be processed, need to be communicated over the network 108. It will be further recognized that more than one airship such as the airship 104 may be deployed in the location 102, and that while an airship 104 is discussed in detail here due to its low cost and easy maneuverability, any number of moving devices may be employed, such as remote control cars, trains or other devices traveling on rails or guides, robots maneuvering through their own sensing of the environment, or any other device capable of carrying a camera and navigating within the environment in which the system 100 is to be used.

The airship 104 provides mounting opportunities for numerous additional elements, providing functions enhancing or supplementing in addition to the price and product information surveying described here. For example, the airship 104 might display advertisements, in the form of text and images painted or projected on the airship 104. The airship 104 might also be equipped with projection devices, such as a laser projection device 160. The laser projection device 160, or an alternative projection device, might project advertisements on surfaces of the environment in which the airship 104 is used, such as the walls or ceiling, and a laser projection device such as the device 160 might provide a capability to write information on laser writable labels.

The airship 104 might also have an onboard illuminator 162, providing an enhanced ability to operate in a dark environment. In addition to providing price and product information surveying, the video information provided by cameras such as the cameras 105, 150, and 152, might be used to provide security information, by providing information for image processing or accessible as a live video feed, for example.

FIG. 2 illustrates additional details of the airship 104, used in the system 100 of FIG. 1. The airship 104 includes a balloon 202, suitably filled with helium, and a suspended gondola 204. The gondola 204 suitably contains radio control receivers and control electronics to control propellers 206 and 208, which are visible here. The propellers 206 and 208 are rotated by a battery powered electric motor and provide motive force and directional control. The airship 104 may suitably be a DRAGANFLY MACH IIIZ Remote Controlled 3 Channel Airship America R C Blimp, typically provided with a radio control transmitter 210. The functions of the radio control transmitter 210 may be duplicated by the computer 110, and communicated to the airship 104 through the radio control transmitter 116. The signals emitted by the radio control transmitter 116 are suitably modeled after those emitted by the radio control transmitter 210. The airship 104 provides mounting opportunities for elements such as the camera 105, the camera platform 106, and the other elements shown in FIG. 1 and discussed above.

FIG. 3 shows a partial view of the airship 104, giving a closer view of the gondola 202 and the propellers 206 and 208, as well as a propeller 212, used to manage the altitude of the airship 104. A radio control receiver, and mechanisms for converting signals received by the radio control receiver to control inputs to the propellers 206, 208, and 212, are concealed within the gondola 202 and not visible here, but these elements of the airship 104 are suitably similar to those typically used in radio controlled vehicles.

FIG. 4 illustrates additional details of the computer 110, showing the processor 112, memory 114, long term storage 115, and bus 118. The computer 110 hosts software and data used to control the airship 104 and the camera 105, to perform image processing in order to navigate the airship 104 and to produce data relating to the content and accuracy of price labels and the presence or absence and arrangement of articles on store shelves, and to manage data related to price labels and articles. The software and data is suitably stored in the long term storage 115 and transferred to memory 114 as needed for execution or other use by the processor 112.

The long term storage 115 suitably hosts the price lookup database 120, as well as additional data and software used to control, communicate with, and receive and process information from, the airship 104 or any other camera platform and camera used to perform information maintenance in the system 100. The long term storage 115 hosts an image recognition module 402, suitably including as submodules an optical character reader module 403 and a bar code image processing module 404. The long term storage 115 also suitably hosts a camera control module 405, a navigation module 406, a price and product information maintenance module 408, a navigation information database 410, the price lookup database 120, and the exceptions log 144, with information being added to the exceptions log through the operation of the system 100 of which the computer 110 is a component.

The price lookup database 120 suitably includes product identification information, such as product code and descriptive information, as well as pricing information, and may also include additional product information including but not limited to images of the products themselves. The price lookup database 120 can be searched in any way desired.

For example, the bar code image processing module 404 may be used to generate bar code information in the form of text or numeric information, and this information may be used as index information to retrieve product identification. The price lookup database 120 can be the same price lookup database used in transactions. The image recognition module 402 may process characters appearing on shelf labels in order to interpret the human readable text and numerals on the labels, and may process any bar codes appearing on shelf labels to convert the bar code information to text information, such as product codes. The price and product information maintenance module 408 may use shelf label information presented by the image recognition module 402 to search the price lookup database 120.

The price and product information maintenance module 408 compares information appearing on each shelf label to corresponding information appearing in the price lookup database 120 to make sure that human readable and encoded price and product information appearing on a shelf label matches the information appearing in the price lookup database 120. The price and product information maintenance module 408 suitably constructs and updated the exceptions log 144 as well as an update file 414, both of which may be retrieved and reviewed at any time, or may be transmitted to an appropriate employee, such as an employee having a responsibility to maintain price labels.

The price and product information maintenance module 408 also suitably constructs a review log 416, indicating when each shelf label was last reviewed, and may also include a more or less complete review history for each shelf label. The review log 416 may be used by the price and product information maintenance module 408 to determine which labels should have highest priority for examination, and this information may be used in determining routing for the airship 104.

The navigation module 406 receives information from the image recognition module, if navigation is being performed with respect to visual indicators, and from other navigational devices, such as beacons and receivers, if navigation is being performed by other means. The navigation module 406 monitors the location of the airship 104 and directs the airship 104 along a designated route, such as a route computed by a human operator and made accessible to the navigation module 406, or computed by the price and product information module 408, for example, a routing calculated to examine shelf labels that have not recently been examined. Alternatively, the navigation module 406 may direct the airship along a routing that is calculated during navigation, for example, consulting the review log 416 in order to determine which labels should be reviewed and constructing a routing to efficiently direct the airship 104 to those labels.

The navigation module 406 may take additional considerations into account in directing the airship 104. For example, the navigation module 406 may monitor the status of an onboard battery of the airship 104, for example, by tracking the operating time of the airship 104 or by consulting status information transmitted by the airship 104 over the wireless network 108. When the battery level reaches a predetermined lower limit, the navigation module 406 directs the airship 104 to a charging station. Numerous airships may be used in a system such as the system 100, either simultaneously or with one airship operating and others held in reserve. If airships are operating simultaneously, the navigation module 406 simply modifies the routing of other available airships in order to provide efficient review with the available airships, or alternatively simply continues directing the additional airships along their courses. When the airship 104 becomes available again, the navigation module 406 directs it as needed, either resuming its original routing or directing it along a modified routing to provide efficient review of the labels remaining to be checked, taking into account labels that have been checked during the period of inactivity.

The navigation module 406 may suitably direct the airship 104 by using references disposed to mark waypoints in a routing, where a change in direction may be expected. The airship 104 travels past shelf labels en route to a waypoint, and the shelf labels may themselves be used as markers. For example, the airship 104 may hover near a shelf label while the camera control module directs the camera 106 to capture an image of its field of view including the shelf label and the image recognition module 402 processes the image to interpret information reflected in the shelf label, for example, converting characters and bar codes to text. The navigation module 406 may then direct the airship 104 to another shelf label near to the first, and so on. When the airship reaches a reference marker, such as the marker 132A marking the end of the aisle 134A, the navigation module 406 may command the airship 104 to change directions so as to travel to another specified reference marker. The airship 104 travels toward the new marker, pausing and maneuvering as needed to examine shelf labels.

To take an example, returning to the system of FIG. 1, the navigation module 406 may direct the airship 104 to proceed toward the marker 132A. Upon arrival at the marker 132A, the navigation module 406 directs the airship 104 to turn in the known direction of the marker 132B, and then to turn again in the known direction of the marker 126D. The airship 104 then proceeds down the aisle 134B, from the marker 126D toward the marker 126E, examining shelf labels as it travels along its path. The field of view of the camera 105 may suitably include multiple shelf labels, and shelf labels within the field of view of the camera 105 may be examined both to process and use the shelf label information for evaluation and comparison against the price lookup table, and also to determine the approximate location of the airship and to ascertain or confirm the desired direction of continued travel of the airship 104. Once the airship 104 arrives at a direction change point, such as the marker 126F, the navigation module 406 commands changes in direction so as to continue travel along the planned path. Thus, the accuracy of shelf labels can be checked, and where in inaccuracy has been detected, it can be noted for manual correction by store personnel who may be automatically notified by the system, for example.

As an alternative, reference markers may be placed at maneuvering points, and the airship 104 directed to selected maneuvering points and then directed toward labels in the vicinity of the maneuvering point. For example, the navigational module 406 might direct the airship 104 to the marker 126A. When the airship 104 arrived at the marker 126A, it could be directed outward from the marker 126A, to survey labels and other objects in the vicinity of the marker 126A. The navigational module 406 could then direct the airship 104 back toward the marker 126B, where it could then be directed outward from the marker 126B, and so on.

As a further alternative, navigation can be conducted simply by directing the airship 104 from one label location to another, without the use of special navigational references.

In addition to reference markers and labels, the navigation module 406 may receive information relating to features of the environment in which the airship 104 is operating. For example, the image recognition module 402 may detect obstacles and transfer information about the obstacles to the navigation module 406, which may respond to the presence of obstacles by choosing a path around the obstacles, or simply by changing direction to allow a trial and error process that will move the airship 104 clear of the obstacle.

As the airship 104 travels, the camera control module 405 directs the camera 105 so as to bring objects of interest into the field of view of the camera 105. The image recognition module 402 captures and evaluates images, isolating objects of interest and performing processing to identify the objects, or to discern information about the objects. If a less than comprehensive survey is to be performed, the image processing module 402 takes into account position information for the airship 104 so that image recognition need not be performed when the airship 104 is not between areas where examination of shelf labels and shelf contents is called for.

In addition to comparing shelf labels against the price lookup database, as described above, the product information and maintenance module 408 may examine the shelf contents themselves. Information that may be evaluated may include a whether or not shelf area dedicated to a particular product is well stocked or nearly empty of products, and whether the products are well organized or loosely arranged. In addition, the identities and quantities of the products may be noted and compared against stored information, against information represented by the shelf labels, or both, in order to generate information relating to whether products are improperly shelved or whether product inventory matches stored inventory information.

Product organization may be evaluated by evaluating the general shape of the assembly of products and the spacing between products, with a regular shape and a tight spacing both indicating organization and an irregular shape and a looser spacing both tending to indicate looser organization. Other aspects of product organization, such as whether products are properly squared up, for example, may also be evaluated.

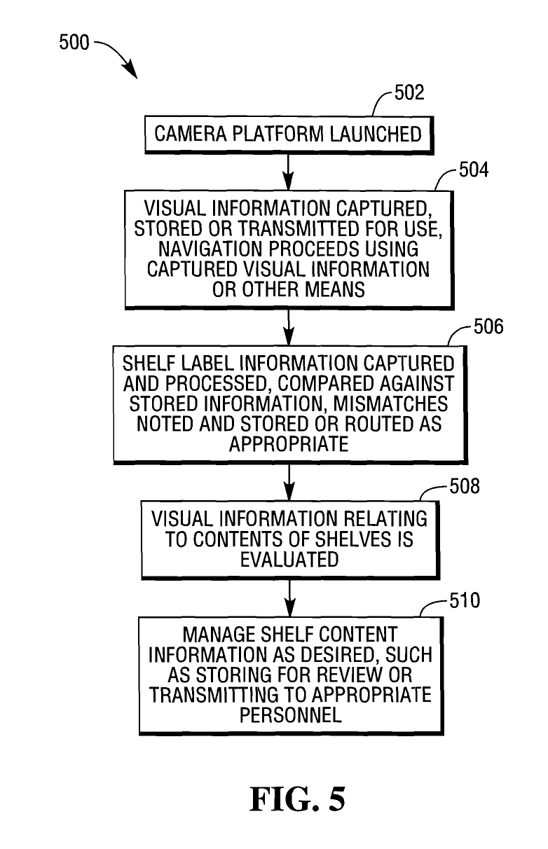

FIG. 5 illustrates the steps of a process 500 of pricing and product information maintenance according to an aspect of the present invention. The process 500 may suitably be carried out using a system such as the system 100 of FIG. 1. At step 502, a camera platform is launched. Depending on the particular features desired, the camera platform may be externally controllable, whether by an automated control system or a human operator, or may be autonomous, sensing and responding to cues in its environment. The platform may be any suitable mobile device capable of motion in the intended space.

At step 504, as the platform moves through the space, visual information is captured providing information about elements of the environment to be used for navigation control and information such as product and pricing information that is to be collected and evaluated. Image processing may be used to identify navigation references and to interpret shelf labels and evaluate the contents of shelves. Alternatively, one or both of control of the platform and interpretation of the visual information may be performed by an employee who may have the ability to control the platform and to see the visual information coming into the field of view of a camera carried by the platform. At step 506, as shelf label information is captured and processed, the information is compared to stored price and product information, for example, by comparing it to information stored in a price lookup table. If the shelf label information does not match the stored price and product information, a mismatch is noted. The mismatch information may suitably be stored for later review, may be provided to an employee responsible for shelf label maintenance, or both.

At step 508, when shelf areas come into the field of view of the camera carried by the camera platform, information relating to the contents of the shelves is evaluated, such as whether the shelves are well stocked or empty, and whether the products on the shelves are well organized or loosely organized. At step 510 shelf content information maybe managed as desired, for example, stored for review or transmitted to personnel responsible for stock maintenance. The shelf content information may also be compared against shelf label, as well as or in addition to stored inventory information and discrepancies noted, for example, by updating a discrepancy file or by transmitting the information to appropriate employees.

While the present invention is disclosed in the context of a presently preferred embodiment, it will be recognized that a wide variety of implementations may be employed by persons of ordinary skill in the art consistent with the above discussion and the claims which follow below.

I claim:

1. A computer for managing product and pricing label and inventory information, comprising:
one or more long term storage devices for storing files and software;
one or more memory devices for temporary storage of data; and
a processor operating under the control of software stored in the memory devices and long term storage devices, the processor operative to receive visual data transmitted from a digital camera carried by a mobile camera platform and to use the visual data to generate information relating to objects coming within a field of view of the digital camera.

2. The computer of claim 1, wherein the processor is further operative to receive visual information relating to navigational references in the environment in which the camera platform operates and to interpret the visual information to determine position and routing information for the camera platform.

3. The computer of claim 1, wherein the visual data includes visual images of shelf labels and wherein the processor is operative to interpret the visual images of shelf labels to extract information reflected by the shelf labels and to compare information for each shelf label for which information is so extracted against corresponding stored information relating to product and pricing information for a product associated with the shelf label.

4. The computer of claim 1, wherein the visual data includes visual images of products and wherein the processor is operative to interpret the visual images to produce product information identifying products within a field of view of the digital camera.

5. The computer of claim 4, wherein the processor is further operative to compare the product information against stored inventory information.

6. The computer of claim 3, wherein the visual data further includes visual images of products and wherein the processor is operative to interpret the visual images to produce product information identifying products within a field of view of the digital camera, the processor being further operative to compare product information against shelf label information and to identify discrepancies between product information and corresponding shelf label information.

7. The computer of claim 2, wherein the processor uses the position and routing information to create navigational commands to be used in directing the camera platform.

8. The computer of claim 7, wherein the camera platform is a freely moving lighter than air craft and wherein the navigational commands include commands for adjusting the altitude of the camera platform.

9. The computer of claim 3, wherein the long term storage device stores an image recognition module for interpreting visual information, and wherein the image recognition module includes an optical character recognition module for interpreting text characters and a bar code image decoding module for interpreting a visual image of a bar code in order to extract text information from the bar code.

10. A mobile camera platform, comprising;
a controllable transport device, the transport device being operative to receive and respond to navigational commands to direct the transport device to desired locations;
a digital camera mounted on the transport device, the camera being operative to receive commands so as to direct the field of view of the camera to objects of interest within its environment, the camera being operative to capture visual information and to transmit the visual information to a computer, the visual information being interpreted by the computer to identify objects represented by the visual information and to generate information relating to the objects; and
a navigational controller mounted on the transport device, the navigational controller producing control impulses to control the orientation and direction of movement of the transport device.

11. The mobile camera platform of claim 10, wherein the visual information captured by the digital camera includes visual information relating to shelf labels and wherein the visual information is interpreted by the computer to generate product and pricing information represented by the shelf labels.

12. The mobile camera platform of claim 10, wherein the visual information captured by the digital camera includes visual information relating to products coming within the field of view of the digital camera and wherein the visual information is interpreted by the computer to generate inventor information relating to products within the field of view of the digital camera.

13. The mobile camera platform of claim 10, wherein the navigational controller generates control impulses based on commands received from an external source.

14. The mobile camera platform of claim 13, wherein the digital camera is further operative to capture navigational information relating to visual references in an environment in which the camera platform operates and to transmit the navigational information to the computer, the navigational information being interpreted by the computer to generate position and direction information for the mobile camera platform, and wherein the navigational controller directs the travel of the camera platform based on navigational commands received from the computer.

15. The mobile camera platform of claim 13, wherein the navigational controller receives navigational commands based on directional control inputs from a remote operator.

16. The mobile camera platform of claim 10, further comprising an onboard computer mounted on the transport device, the onboard computer communicating with the navigational controller and the digital camera, the computer receiving and interpreting visual information coming within the field of view of the digital camera.

17. The mobile camera platform of claim 16, wherein the onboard computer is operative to transmit the extracted information to a remote destination.

18. The mobile camera platform of claim 16, wherein the onboard computer is further operative to receive visual information relating to navigational references, and to issue navigational commands to the onboard navigational controller based on the navigational references.

19. A method of pricing and inventory management, comprising the steps of:
directing a mobile camera platform so as to allow capture of visual information coming within the field of view of a digital camera carried by the platform; and
performing image recognition on the visual information to generate information relating to the objects coming within the field of view of the digital camera.

20. The method of claim 19, wherein the visual information includes information relating to shelf labels and wherein performing image recognition includes generating product and pricing information represented by the shelf labels.

21. The method of claim 20, wherein the visual information further includes actual product information relating to products that are present and wherein performing image recognition includes generating information identifying the types and quantities of products present.

22. The method of claim 21, further including a step of comparing the actual product information against the shelf label information.

23. The method of claim 21, further including a step of comparing the actual product information against stored inventory information.

24. The method of claim 19, further comprising the steps of:
capturing visual information relating to navigational references in an environment in which the camera platform operates;
performing visual recognition to interpret the visual information to identify the navigational references; and
computing position and direction information for the camera platform based on the navigational references.

25. The method of claim 24, further comprising directing the motion of the camera platform based on position and direction information calculated based on the navigational references.

26. The method of claim 25, wherein directing the motion of the camera platform comprises directing the camera platform along a predetermined route calculated to capture and process visual information for specified shelf labels.

27. The method of claim 24, wherein the navigational references include one or more shelf labels.

28. The method of claim 20, further comprising a step of comparing the pricing and product information taken from the visual information relating to the shelf labels against stored pricing and product information.
